(19) United States
(12) Patent Application Publication
(10) Pub. No.: US 2009/0015702 A1
(43) Pub. Date: Jan. 15, 2009

(54) ENHANCED IMAGE CAPTURING FUNCTIONALITY

(75) Inventor: Enrique GARCIA ALONSO, Malmo (SE)

Correspondence Address: HARRITY & HARRITY, LLP, 11350 RANDOM HILLS ROAD, SUITE 600, FAIRFAX, VA, 22030, US

(73) Assignee: SONY ERICSSON COMMUNICATINS AB, Lund (SE)

(21) Appl. No.: 11/776,022

(22) Filed: Jul. 11, 2007

(51) Int. Cl. H04N 5/222

(52) U.S. Cl. 348/333.02; 348/E05.022

(57) ABSTRACT

The present invention may be directed to a method, image capturing device and computer program product for providing image capturing functionality as well as to a method, image capturing device and computer program product for enabling the provision of image capturing functionality. An image capturing device that may enable the provision of functionality may capture an image detects its own position and store the image as an image capturing template and position data regarding the position as associated template data to be used for the capturing of further images. An image capturing device providing such functionality may receive a user selection of a stored image for use as an image capturing template, and may present the template in a view finder of the image capturing device. The template may be presented in a semi-transparent version for allowing the template and a scene to be captured to be viewed via the view-finder.

### TECHNICAL FIELD

Embodiments disclosed herein may relate to the field of image capturing devices. Embodiments disclosed herein may be directed to a method, image capturing device, or computer program product for providing enhanced image capturing functionality. Embodiments disclosed herein may be directed to a method, image capturing device, or computer program product for enabling the provision of enhanced image capturing functionality.

### DESCRIPTION OF RELATED ART

Cameras and other image capturing devices have become smaller and smaller and are often present in portable electronic devices like cellular phones. As such, they have become very popular and used by users in various situations.

With the introduction of digital cameras it is easier to handle images in various ways in order to create different effects and presentations. It is, for example, very simple to create slide shows.

### SUMMARY

Embodiments disclosed herein may be directed to providing a tool that may simplify, for a user of an image capturing device, the creation of effects and presentations in relation to captured images.

A first aspect of one embodiment may be directed to a method for providing enhanced image capturing functionality of an image capturing device and may include: receiving a user selection of a stored image for use as an image capturing template, and presenting the template in a view finder of the image capturing device, wherein the template may be presented in a semi-transparent version for allowing the template and a scene to be captured to be viewed via the view-finder.

A second aspect of one embodiment may include the features of the first aspect, wherein data regarding the position of an image capturing device used when capturing the template may be pre-stored and associated with the template, wherein the method may further include detecting the position of the image capturing device, and presenting data in relation to the two positions for allowing the user to place the image capturing device in the same position as the position indicated by the position data associated with the template.

A third aspect of one embodiment may include the features of the second aspect, wherein presenting data may include presenting position data of the two positions.

A fourth aspect of one embodiment may include the features of the second aspect, wherein presenting data may include presenting guidance data for reaching, from the device position, the position indicated by the position data associated with the template.

A fifth aspect of one embodiment may include the features of the second aspect, wherein data regarding the orientation of the image capturing device used when capturing the template may be pre-stored associated with the template. The fifth aspect may further include presenting guidance data in relation to the stored orientation data for allowing the user to orient the image capturing device with the same orientation as the orientation indicated by the orientation data associated with the template.

A sixth aspect of one embodiment may include the features of the fifth aspect, and may further include detecting the orientation of the image capturing device. According to the sixth aspect, presenting guidance data may include presenting guidance data for reaching, from the device orientation, the orientation indicated by the orientation data associated with the template.

A seventh aspect of one embodiment may include the features of the first aspect, wherein there may be pre-stored image capturing settings associated with the template. The seventh aspect may further include applying at least one of the settings on the image capturing device for allowing images to be captured at the same conditions as the template was captured at.

An eighth aspect of one embodiment may be directed to an image capturing device for providing enhanced image capturing functionality. The eighth aspect may further include: an image capturing unit, an image store that may include at least one image, and an image capturing control unit configured to receive a user selection of a stored image for use as an image capturing template, and present the template in a view finder for the image capturing unit, herein the template may be presented in a semi-transparent version for allowing the template and a scene to be captured to be viewed via the view-finder.

A ninth aspect of one embodiment may include the features of the eighth aspect, wherein the image store also may include data regarding the position of an image capturing device used when capturing the template and being stored associated with the template. The ninth aspect may further include a positioning unit arranged to detect the position of the image capturing device, and the image capturing control unit may be further arranged to present data in relation to the two positions for allowing the user to place the image capturing device in the same position as the position indicated by the position data associated with the template.

A tenth aspect of one embodiment may include the features of the ninth aspect, wherein the image capturing control unit when presenting data may be configured to present position data of the two positions.

An eleventh aspect of one embodiment may include the features of the ninth aspect, wherein the image capturing control unit when presenting data may be configured to present guidance data for reaching, from the device position, the position indicated by the position data associated with the template.

A twelfth aspect of one embodiment may include the features of the ninth aspect, wherein the image store also may include data regarding the orientation of the image capturing device used when capturing the template and being stored associated with the template and the image capturing control unit being further configured to present guidance data in relation to the stored orientation data for allowing the user to orient the image capturing device with the same orientation as the orientation indicated by the orientation data associated with the template.

A thirteenth aspect of one embodiment may include the features of the twelfth aspect, and may further include an orientation detector for detecting the orientation of the image capturing device and the image capturing control unit when being configured to present guidance data may be configured to present guidance data for reaching, from the device orientation, the orientation indicated by the orientation data associated with the template.

A fourteenth aspect of one embodiment may include the features of the eighth aspect, wherein there are image capturing settings associated with the image template and the image capturing control unit may be further configured to apply at least one of the settings on the image capturing unit for allowing images to be captured at the same conditions as the template was captured at.

A fifteenth aspect of one embodiment may include the features of the eighth aspect, wherein the image capturing device may include a portable electronic device.

A sixteenth aspect of one embodiment may include the features of the fifteenth aspect, wherein the image capturing device may include a portable communication device.

A seventeenth aspect of one embodiment may include the features of the sixteenth aspect, wherein the image capturing device may include a cellular phone.

An eighteenth aspect of one embodiment may be directed to a computer program product for providing enhanced image capturing functionality of an image capturing device and may include computer program code to make an image capturing device perform, when the code may be loaded into the image capturing device: receive a user selection of a stored image for use as an image capturing template, and present the template in a view finder of the image capturing device, wherein the template may be presented in a semi-transparent version for allowing the template and a scene to be captured to be viewed via the view-finder.

A nineteenth aspect of one embodiment may be directed to a method for enabling the provision of enhanced image capturing functionality of an image capturing device that may include: capturing an image, detecting the position of the image capturing device, and storing the image as an image capturing template and position data regarding the position as associated template data to be used for the capturing of further images A twentieth aspect of one embodiment may include the features of the nineteenth aspect, and may further include detecting the orientation of the image capturing device and storing also orientation data regarding the orientation as template data.

A twenty-first aspect of one embodiment may include the features of the nineteenth aspect, and may further include storing the settings applied when capturing the image as template data.

A twenty-second aspect of one embodiment may be directed to an image capturing device for enabling the provision of enhanced image capturing functionality of an image capturing device and may include: an image capturing unit, an image store, a positioning unit and an image capturing control unit configured to order the image capturing unit to capture an image, order the positioning unit to detect the position of the image capturing device, and tore the image as an image capturing template and position data regarding the position as associated template data to be used for the capturing of further images.

A twenty-third aspect of one embodiment may include the features of the twenty-second aspect, and may further include an orientation detector for detecting the orientation of the image capturing device and the image capturing control unit being further configured to store also orientation data regarding the orientation as template data.

A twenty-fourth aspect of one embodiment may include the features of the twenty-second aspect, wherein image capturing control unit may be further configured to store settings applied by the image capturing unit when capturing the image as template data.

A twenty-fifth aspect of one embodiment may include the features of the twenty-second aspect, wherein the image capturing device may include a portable electronic device.

A twenty-sixth aspect of one embodiment may include the features of the twenty-fifth aspect, wherein the image capturing device may include a portable communication device.

A twenty-seventh aspect of one embodiment may include the features of the twenty-sixth aspect, wherein the image capturing device may include a cellular phone.

A twenty-eighth aspect of one embodiment may be directed to a computer program product for enabling the provision of enhanced image capturing functionality of an image capturing device and may further include computer program code to make an image capturing device perform, when the code may be loaded into the image capturing device: capture an image, detect the position of the image capturing device, and store the image as an image capturing template and position data regarding the position as associated template data to be used for the capturing of further images.

The term “comprises/comprising” when used in this specification may be taken to specify the presence of stated features, integers, steps or components, but does not preclude the presence or addition of one or more other features, integers, steps, components or groups thereof.

### BRIEF DESCRIPTION OF THE DRAWINGS

Embodiments will now be described in more detail in relation to the enclosed drawings, in which:

FIG. 1 schematically shows an exemplary front view cellular phone according to one embodiment;

FIG. 2 shows a side view of the exemplary cellular phone shown in FIG. 1;

FIG. 3 shows a block schematic of different exemplary units provided in the phone in one embodiment;

FIG. 4 shows a flow chart of an exemplary process for enabling the provision of enhanced image capturing functionality according to one embodiment;

FIG. 5 shows a flow chart of a number of an exemplary process for providing enhanced image capturing functionality according to one embodiment;

FIG. 6A schematically shows an exemplary first scene presented by a view-finder for capturing an image to be used as a template;

FIG. 6B schematically shows an exemplary template for being presented by a view-finder;

FIG. 6C schematically shows an exemplary second scene presented by a view-finder together with the template in order to capture an image; and

FIG. 6 schematically shows an exemplary computer program product in the form of a CD ROM disc including computer program code for carrying out one embodiment.

### DETAILED DESCRIPTION OF EMBODIMENTS

Embodiment disclosed herein may provide a tool that may the creation of effects and presentations in relation to image capturing devices. Embodiments may provide enhanced image capturing functionality to the enjoyment of many users. Embodiments disclosed herein may provide functionality that may normally be associated with a professional photographer. Embodiments disclosed herein may be produced at low costs because some hardware components disclosed may exist in image capturing devices.

Embodiments disclosed herein may relate to an image capturing device. The image capturing device may be a camera, still image camera or a video camera, e.g., a camcorder, but it may also be provided as a portable electronic device including image capturing functionality. In the following, embodiments may be described in relation to an image capturing device being provided through a portable electronic device that may be a portable communication device. In one embodiment, it may be exemplified by a cellular phone. Embodiments may not be limited to cellular phones but can be used in relation to other portable electronic devices. Embodiments may include a communicator or another portable electronic devices like a lap top computer, a palm top computer or an electronic organizer as long as these devices have image capturing functionality.

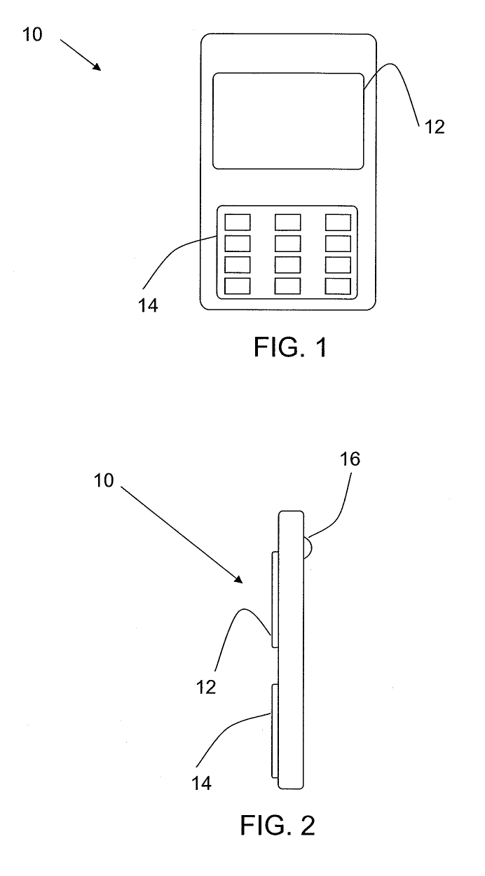

FIG. 1 shows an exemplary front view of a cellular phone 10. FIG. 2 shows an exemplary side view of the phone 10. The phone 10 may include a user output unit in the form of a display 12 on a front side. This display may typically be used for providing a view-finder for capturing images. The phone 10 also may include a set of user input units in the form of a number of keys on a keypad 14 on the front side. On the back side of the phone 10 there may be provided an image capturing unit 16 in the form of a digital camera. This camera can be used to capture images of different scenes.

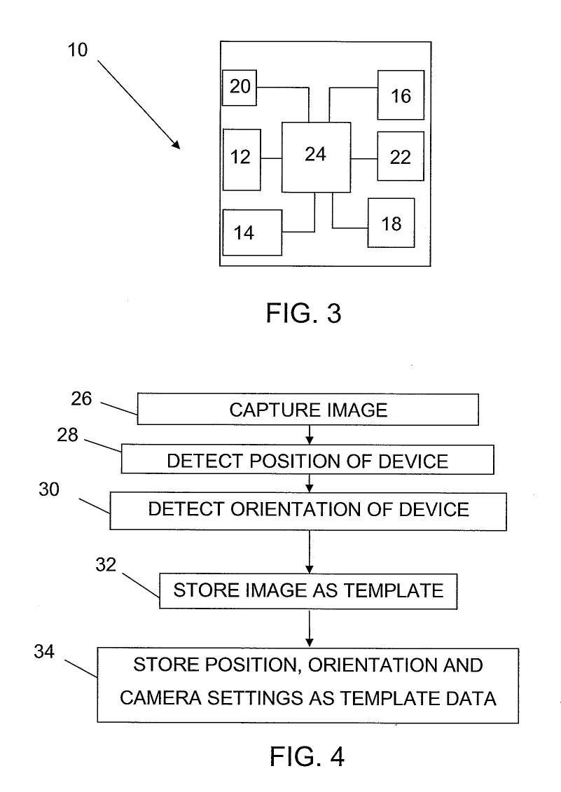

FIG. 3 shows a block schematic of the different exemplary units in the phone 10 that may be used in relation to embodiments disclosed herein. The phone 10 may include a user input unit 14, e.g., keypad 14, a user output unit, e.g., display 12, and an image capturing unit 16. The image capturing unit 16 may typically include a lens connected to a digital image receiving unit, which converts projected images into digital images. Such a digital image receiving unit may include a CCD (Charge-Coupled Device) unit. All the above described units are connected to an image capturing control unit 24, which controls the functionality of the phone 10 in relation to the image capturing unit 16. There may be included a positioning unit 20, which may be a GPS positioning unit, an orientation detector 18 as well as an image store 22. All these units 18, 20 and 22 may also be connected to the image capturing control unit 24. The orientation detector 18 may detect the orientation of the phone, and more particularly the orientation in relation to the image capturing unit 16 and may be provided with a compass or other suitable orientation detection means in order to determine the orientation. Other ways of determining the orientation may include determining the reception pattern or signal strength as detected via antenna for a given orientation and a given position of the phone. The phone may include several more units and functions.

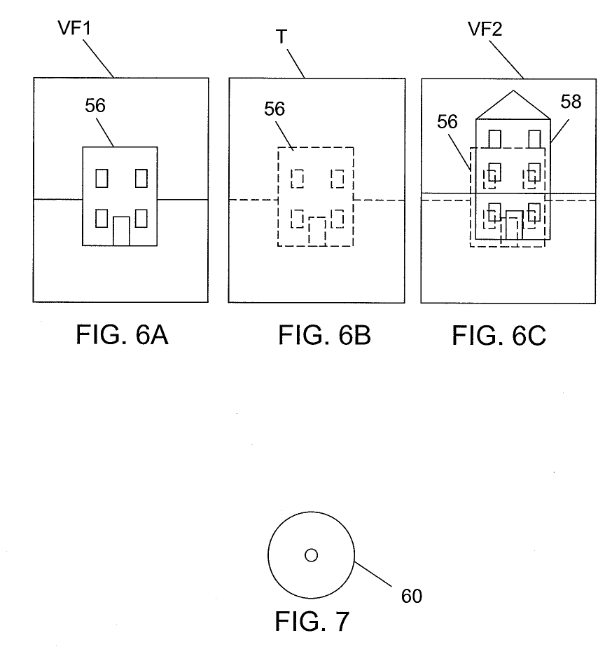

The functioning of embodiments will now be described with reference to FIGS. 1-4. FIG. 4 shows a flowchart of an exemplary process according to one embodiment. The exemplary process may be carried out in the phone 10. The functioning of embodiments may also be described with respect to FIGS. 6A and 6B, which schematically show an exemplary first view-finder view VF1 presented by a view-finder for capturing an image capturing template to be used as a template and the template T for being presented by a view-finder.

The method of one embodiment may start with the capturing of an image based on inputs of the user. The image captured may be an image of a scene presented by the view-finder, which view-finder may be provided via the display 12. The view VF1 presented may be a first scene that may be schematically shown in FIG. 6A. This view VF1 in FIG. 6A shows an object in the form of a partly constructed building 56. At the capturing of this scene shown in the view VF1, the user may be presented, by the image capturing control unit 24, to select if the image to be captured is to be used as an image capturing template. In case the user does select the image to be captured to be a template T, through using the keypad 14 (for example), the process of FIG. 4 may be followed. If the user does not select the image to be a template, normal image capturing may be performed.

If the user selected to capture a template, the image may be captured (block 26) through the image capturing control unit 24 detecting that a key on the keypad 14 has been depressed and ordering the image capturing unit 16 to capture an image. The captured image may be forwarded from the image capturing unit 16 to the image capturing control unit 24. In this capturing the user may have made a number of camera settings, such as zoom. These settings may also be forwarded to the image capturing control unit 24. The image capturing control unit 24 at the same time may order the positioning unit 20 to detect the position of the phone 10. The positioning unit 20 may detect the position (block 28) and may provide position data to the image capturing control unit 24. The image capturing control unit 24 at the same time also may order the orientation detector 18 to detect the orientation of the phone, e.g., in which way the phone is directed for the given position. The orientation detector 18 may detect the orientation (block 30) and may provide orientation data to the image capturing control unit 24. As mentioned before, this data may include a compass direction, the antenna pattern, or it may be the signal strength associated with the orientation at this position. The image capturing control unit 32 may store the image as a template T (block 32), as well as the position data, orientation data and camera settings as template data associated with the template T (block 34). The template T and the template data may be stored in the image store 22.

The stored image may be used as a template for capturing further images. It may be possible for a user to select a previously stored image as a template. For this scenario the phone may store the above mentioned template data for all images being captured. In some embodiments, no template data is stored and used.

The user of the phone may now use the stored template in the capturing of images. When the template T is used, it may be presented in the view-finder as a semi-transparent image. Thus a semi-transparent version of the previously captured image may be presented. The image version presented may be between 7-30% transparent, and, in one embodiment, about 10% transparent. The template may furthermore be zoomable. That the template when being presented is semi-transparent is exemplified in FIG. 6B, through showing the template T as a dashed version of the image of the view-finder view VF1 in FIG. 6A.

If a user may wish to use the stored template, he/she may be presented with the option to capture an image using the template. This may be done a long time after the image that is used as template was captured. One reason for doing this is that perhaps the user would like to create a slide show showing the progress of the construction of the building 56 in the template T, through capturing images at the same position a later points in time.

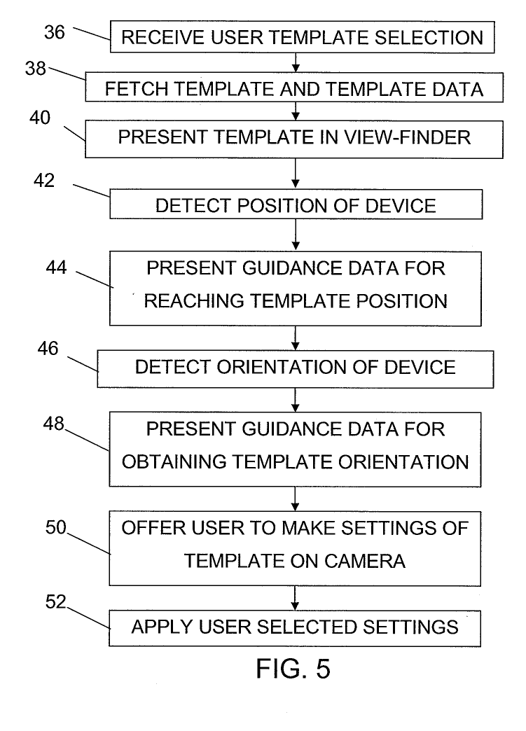

How this can be done will now be described with reference also being made to FIG. 5, which shows an exemplary process for providing enhanced image capturing functionality being carried out in the phone 10 as well as to FIG. 6C, which shows an exemplary second view VF2 presented by the view-finder together with the template T.

The user may select to capture images using the template T via the keypad 14. This template selection may be received by the image capturing control unit 24 (block 36). The image capturing control unit 24 may fetch the template T and template data from the image store 22 (block 38). The image capturing control unit 24 may present the template T in the view-finder, e.g., the semi-transparent version of the previously captured image. This template may be presented in the display 12 together with the scene as a second view-finder view VF2 (block 40). As this is done, alpha-blending may be performed on this template T and the scene in order to show the combined images in the second view-finder view VF2. If the scene being captured is in the same position as the template T was captured in, it may be possible to see the view-finder image overlaid on the template T as is indicated in FIG. 6C. It is possible to align the object 56 of the template with the object 58 of the scene. The image capturing control unit 24 may order the positioning unit 20 to detect the current position of the phone 10.

The positioning unit 20 may detect the position (block 42), and may provide position data of the detected position to the image capturing control unit 24. The image capturing control unit 24 may also obtain the template position data and, based on these, it may present data in relation to the two positions for allowing the user to place the phone 10 in the position in which the template was captured. It may do this through presenting position data for the two positions in the view-finder. The user may easily move so that the correct position may be obtained in that the two positions have the same value. However, it may also present guidance data for reaching the position indicated by the position data of the template data (block 44), e.g., provide instructions for reaching the position indicated by the template data from the current position of the phone, such as giving instructions like move 10 meters north or some similar instruction. The image capturing control unit 24 may at the same time order the orientation detector 18 to detect the current orientation of the phone, e.g., in which way the phone may be directed for the given position. The orientation detector 18 may detect the orientation (block 46), and may provide orientation data of the detected orientation to the image capturing control unit 24.

The unit 24 may compare the current orientation with the orientation indicated by orientation data in the template data. Also, it may provide guidance data for allowing the user to orient the phone 10 in the template orientation, e.g., for reaching the orientation indicated by the template data (block 48). The guidance may be an instruction such as turn 90 degrees left or some similar instruction. As an alternative, it may be possible to only use the orientation data of the template data and not current position and thus only indicate the orientation that the phone should have without any reference to the current position. The image capturing control unit 24 may offer the user to apply the template settings also on the image to be captured (block 50). The user may select one or more of these settings, which may be applied on the image capturing unit 16 by the image capturing control unit 24 (block 52), and the image may be captured in the same way as was described earlier.

In this way a user may capture an image from the same view as the template was captured in. The image may thus be captured from the same position, with the same orientation and using the same settings. When in the correct position, the user may furthermore easily align the scene presented by the view-finder with the template and thus it may be possible to capture images that are aligned with each other. In this way, it may be possible for a user, for example, to create a slide show of a certain captured object, like, for example, the construction of a building or the change of a location over the various seasons of the year. Embodiments disclosed herein may enable the composing of various combined images, for example, through combining the template and another image for creating new effects through blending the images. The image that is used as a template may furthermore also be used a regular image that is part of, for example, a slide show.

In this way it is possible to provide enhanced image capturing functionality to the enjoyment of many users, which functionality is normally only possible to achieve by a professional photographer.

Embodiments disclosed herein may be implemented without the provision of settings. The user may him/herself easily adjust the template or also the image capturing unit in order to achieve the composition of the scene he/she wants to capture. Also the orientation data may not be needed. A user may likewise easily obtain the scene composition he wants by changing the orientation of the image capturing device until the objects in the scene to be captured are aligned with the objects in the template. Therefore the orientation detector may in some embodiments be omitted from the image capturing device. The position data may be good to have when the user wants to capture different images of the same object. However, this may be omitted, especially if compositions are to be made of a template that is completely different from the object to be captured. Therefore, the positioning unit may be omitted in some versions of the image capturing device. In one embodiment, it may be possible that the template created by one image capturing device and the possibly existing associated template data may be transferred from this image capturing device to another image capturing device, in which other image capturing device the template is put to use. The selection of a template may also be the selection to use an ordinary image that has not been stored as a template. This image may be processed for being semi-transparent when using it as a template.

In one embodiment, software may be provided to an image capturing unit, display, and keypad that may exist in many portable electronic devices. Thus, embodiments disclosed herein may be produced at low costs.

The capturing control unit in the phone may be provided in the form of one or more processors together with a program memory store containing program code for performing the functions of this capturing control unit. This program code can also be provided on a computer program product, like a CD ROM disc, a memory stick or another suitable data carrier, which performs embodiments disclosed herein when being loaded into the device. One such exemplary medium is schematically shown in FIG. 7, which shows a CD ROM disc 60, on which the program code for the phone may be provided. The program code may furthermore be provided on an external server and downloaded from there into the phone. The orientation detector may be implemented through software in combination with a compass or an antenna and signal strength measuring unit. Such a signal strength measuring unit may be provided as a part of the radio communication circuits used by a phone. The image store may be provided through any suitable memory such as a RAM, ROM or a flash memory.

The template described above is not limited to still images but may also be applied when capturing video. Therefore the present invention is only to be limited by the following claims.

1. A method for providing image capturing functionality of an image capturing device comprising:
receiving a user selection of a stored image for use as an image capturing template, and
presenting the template in a view finder of the image capturing device,
wherein the template is presented in a semi-transparent version for allowing the template and a scene to be captured to be viewed via the view-finder.

2. The method according to claim 1, wherein data regarding a position of an image capturing device used to capture said template is pre-stored and associated with said template, the method further comprising
detecting the position of the image capturing device, and presenting data in relation to two positions for allowing the user to place the image capturing device in the same position as the position indicated by the position data associated with the template.

3. The method according to claim 2, wherein presenting data comprises presenting position data of the two positions.

4. The method according to claim 2, wherein presenting data comprises presenting guidance data for reaching, from the position of the image capturing device, the position indicated by the position data associated with the template.

5. The method according to claim 2, wherein data regarding the orientation of said image capturing device used to capture said template is pre-stored and associated with said template, the method further comprising
presenting guidance data in relation to the pre-stored orientation data for allowing the user to orient the image capturing device with the same orientation as the orientation indicated by the orientation data associated with the template.

6. The method according to claim 5, further comprising detecting the orientation of the image capturing device and wherein presenting guidance data comprises presenting guidance data for reaching, from the orientation of the image capturing device, the orientation indicated by the orientation data associated with the template.

7. The method according to claim 1, wherein there are pre-stored image capturing settings associated with the template, the method further comprising applying at least one of said settings on the image capturing device for allowing images to be captured at the same settings at which the template was captured.

8. An image capturing device for providing image capturing functionality and comprising:
an image capturing unit,
an image store comprising at least one image, and
an image capturing control unit configured to
receive a user selection of a stored image for use as an image capturing template, and
present the template in a view finder for the image capturing unit,
wherein the template is presented in a semi-transparent version for allowing the template and a scene to be captured to be viewed via the view-finder.

9. The image capturing device according to claim 8, wherein the image store also comprises data regarding a position of an image capturing device used to capture said template, the stored data being associated with said template, the device further comprising
a positioning unit arranged to detect the position of the image capturing device, wherein the image capturing control unit is further arranged to present data in relation to two positions for allowing the user to place the image capturing device in the same position as the position indicated by the position data associated with the template.

10. The image capturing device according to claim 9, wherein said image capturing control unit, when presenting data, is configured to present position data of the two positions.

11. The image capturing device according to claim 9, wherein said image capturing control unit, when presenting data, is configured to present guidance data for reaching, from the position of the image capturing device, the position indicated by the position data associated with the template.

12. The image capturing device according to claim 9, wherein the image store also comprises data regarding the orientation of an image capturing device used to capture the template, the stored data regarding the orientation being associated with said template, wherein said image capturing control unit being further configured to
present guidance data in relation to the stored orientation data for allowing the user to orient the image capturing device with the same orientation as the orientation indicated by the orientation data associated with the template.

13. The image capturing device according to claim 12, further comprising an orientation detector for detecting the orientation of the image capturing device and the image capturing control unit, when being configured to present guidance data, is configured to present guidance data for reaching, from the orientation of the image capturing device, the orientation indicated by the orientation data associated with the template.

14. The image capturing device according to claim 8, wherein there are image capturing settings associated with the image template and said image capturing control unit is further configured to apply at least one of said settings on the image capturing unit for allowing images to be captured at the same conditions as at which the template was captured.

15. The image capturing device according to claim 8, wherein the image capturing device includes a portable electronic device.

16. The image capturing device according to claim 15, wherein the image capturing device includes a portable communication device.

17. The image capturing device according to claim 16, wherein the image capturing device includes a cellular phone.

18. A computer program product for providing image capturing functionality of an image capturing device and comprising computer program code to make an image capturing device perform, when said code is loaded into the image capturing device:
receive a user selection of a stored image for use as an image capturing template, and
present the template in a view finder of the image capturing device,
wherein the template is presented in a semi-transparent version for allowing the template and a scene to be captured to be viewed via the view-finder.

19. A method for enabling the provision of image capturing functionality of an image capturing device comprising:
capturing an image,
detecting a position of the image capturing device, and
storing the image as an image capturing template and position data regarding the position as associated template data to be used for the capturing of further images.

20. The method according to claim 19, further comprising detecting an orientation of the image capturing device and storing orientation data regarding the orientation as template data.

21. The method according to claim 19, further comprising storing the settings applied when capturing said image as template data.

22. An image capturing device for enabling the provision of image capturing functionality of an image capturing device and comprising:
an image capturing unit,
an image store,
a positioning unit and
an image capturing control unit configured to
order the image capturing unit to capture an image,
order the positioning unit to detect a position of the image capturing device, and
store the image as an image capturing template and position data regarding the position as associated template data to be used for the capturing of further images.

23. The image capturing device according to claim 22, further comprising an orientation detector for detecting an orientation of the image capturing device and said image capturing control unit being further configured to store also orientation data regarding the orientation as template data.

24. The image capturing device according to claim 22, wherein image capturing control unit is further configured to store settings applied by the image capturing unit when capturing said image as template data.

25. The image capturing device according to claim 22, wherein the image capturing device includes a portable electronic device.

26. The image capturing device according to claim 25, wherein the image capturing device includes a portable communication device.

27. The image capturing device according to claim 26, wherein the image capturing device includes a cellular phone.

28. A computer program product for enabling the provision of image capturing functionality of an image capturing device and comprising computer program code to make an image capturing device perform, when said code is loaded into the image capturing device:
capture an image,
detect a position of the image capturing device, and
store the image as an image capturing template and position data regarding the position as associated template data to be used for the capturing of further images.
